(19) United States
(12) Patent Application Publication
(10) Pub. No.: US 2021/0051757 A1
(43) Pub. Date: Feb. 18, 2021

(54) APPARATUSES AND METHODS FOR A USER EQUIPMENT (UE) TO PROVIDE ASSISTANCE INFORMATION TO TRANSITION OUT OF AN RRC_CONNECTED STATE

(71) Applicant: MEDIATEK INC., Hsinchu City (TW)

(72) Inventors: Li-Chuan TSENG, Hsinchu City (TW); Chia-Chun HSU, Hsinchu City (TW)

(21) Appl. No.: 16/908,427

(22) Filed: Jun. 22, 2020

Related U.S. Application Data
(60) Provisional application No. 62/887,080, filed on Aug. 15, 2019.

(51) Int. Cl. H04W 76/27; H04W 76/30; H04W 8/08

(52) U.S. Cl. CPC H04W 76/27; H04W 8/08; H04W 76/30

(57) ABSTRACT

A User Equipment (UE) including a wireless transceiver and a controller is provided. The wireless transceiver performs wireless transmission and reception to and from a service network. The controller transmits a Radio Resource Control (RRC) message including assistance information to indicate the UE's preference of transition out of an RRC_CONNECTED state to the service network via the wireless transceiver, and receives an RRC Release message from the service network via the wireless transceiver in response to transmitting the RRC message including the assistance information to indicate the UE's preference of transition out of the RRC_CONNECTED state. Also, the controller configures the UE to enter an RRC_IDLE state or an RRC_INACTIVE state from the RRC_CONNECTED state in response to receiving the RRC Release message.

### CROSS REFERENCE TO RELATED APPLICATIONS

This Application claims priority of U.S. Provisional Application No. 62/887,080, filed on Aug. 15, 2019, the entirety of which is incorporated by reference herein.

### BACKGROUND OF THE APPLICATION

### Field of the Application

The application generally relates to mobile communications and, more particularly, to apparatuses and methods for a User Equipment (UE) to provide assistance information to transition out of an RRC_CONNECTED state.

### Description of the Related Art

In a typical mobile communication environment, a User Equipment (UE) (also called Mobile Station (MS)), such as a mobile telephone (also known as a cellular or cell phone), or a tablet Personal Computer (PC) with wireless communications capability, may communicate voice and/or data signals to one or more service networks. The wireless communications between the UE and the service networks may be performed using various Radio Access Technologies (RATs), such as Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA-2000) technology, Time Division-Synchronous Code Division Multiple Access (TD-SCDMA) technology, Worldwide Interoperability for Microwave Access (WiMAX) technology, Long Term Evolution (LTE) technology, LTE-Advanced (LTE-A) technology, etc.

These wireless technologies have been adopted for use in various telecommunication standards to provide a common protocol that enables different wireless devices to communicate on a municipal, national, regional, and even global level. An example of an emerging telecommunication standard is the 5G New Radio (NR). The 5G NR is a set of enhancements to the LTE mobile standard promulgated by the Third Generation Partnership Project (3GPP). It is designed to better support mobile broadband Internet access by improving spectral efficiency, reducing costs, and improving services.

In some cases, a UE may prefer to leave the RRC_CONNECTED state for power saving if it does not expect to transmit or receive data in an upcoming period of time. However, due to the specifications for 5G NR still being under discussion among 3GPP members, many details are not yet identified, including how to allow the UE to indicate its preference of transition out of the RRC_CONNECTED state.

### BRIEF SUMMARY OF THE APPLICATION

The present application proposes to allow a UE to indicate its preference of transition out of the RRC_CONNECTED state via a Radio Resource Control (RRC) message (e.g., a UEAssistanceInformation message), so as to trigger the network side to release the RRC connection for the UE to leave the RRC_CONNECTED state. Advantageously, the power savings accrued by the UE may be improved.

In one aspect of the application, a UE comprising a wireless transceiver and a controller is provided. The wireless transceiver is configured to perform wireless transmission and reception to and from a service network. The controller is configured to transmit a Radio Resource Control (RRC) message comprising assistance information to indicate the UE's preference of transition out of an RRC_CONNECTED state to the service network via the wireless transceiver, receive an RRC Release message from the service network via the wireless transceiver in response to transmitting the RRC message comprising the assistance information to indicate the UE's preference of transition out of the RRC_CONNECTED state, and configure the UE to enter an RRC_IDLE state or an RRC_INACTIVE state from the RRC_CONNECTED state in response to receiving the RRC Release message.

In another aspect of the application, a method is provided. The method comprises the following steps: transmitting an RRC message comprising assistance information to indicate the UE's preference of transition out of an RRC_CONNECTED state to a service network by a UE; receiving an RRC Release message from the service network by the UE in response to transmitting the RRC message comprising the assistance information to indicate the UE's preference of transition out of the RRC_CONNECTED state; and entering an RRC_IDLE state or an RRC_INACTIVE state from the RRC_CONNECTED state by the UE in response to receiving the RRC Release message.

Other aspects and features of the present application will become apparent to those with ordinarily skill in the art upon review of the following descriptions of specific embodiments of the UEs and the methods for a UE to provide assistance information to transition out of an RRC_CONNECTED state.

### BRIEF DESCRIPTION OF DRAWINGS

The application can be more fully understood by reading the subsequent detailed description and examples with references made to the accompanying drawings, wherein:

FIG. 1 is a block diagram of a wireless communication environment according to an embodiment of the application;

FIG. 2 is a block diagram illustrating the UE 110 according to an embodiment of the application;

FIG. 3 is a flow chart illustrating the method for a UE to provide assistance information to transition out of an RRC_CONNECTED state according to an embodiment of the application; and

FIG. 4 is a message sequence chart illustrating the provision of assistance information for the UE 110 to transition out of the RRC_CONNECTED state according to an embodiment of the application.

### DETAILED DESCRIPTION OF THE APPLICATION

The following description is made for the purpose of illustrating the general principles of the application and should not be taken in a limiting sense. It should be understood that the embodiments may be realized in software, hardware, firmware, or any combination thereof. The terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

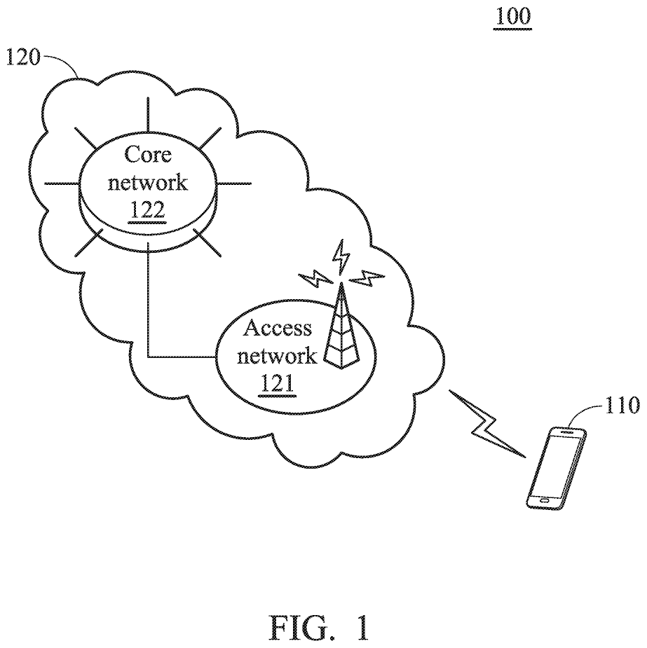

FIG. 1 is a block diagram of a wireless communication environment according to an embodiment of the application.

As shown in FIG. 1, the wireless communication environment 100 may include a User Equipment (UE) 110 and a service network 120, wherein the UE 110 may be wirelessly connected to the service network 120 for obtaining mobile services.

The UE 110 may be a feature phone, a smartphone, a panel Personal Computer (PC), a laptop computer, or any wireless communication device supporting the RAT (e.g., the 5G NR technology) utilized by the service network 120. In another embodiment, the UE 110 may support more than one RAT. For example, the UE may support the 5G NR technology and a legacy 4G technology, such as the LTE/LTE-A/TD-LTE technology, or the WCDMA technology.

The service network 120 may include an access network 121 and a core network 122. The access network 121 is responsible for processing radio signals, terminating radio protocols, and connecting the UE 110 with the core network 122. The core network 122 is responsible for performing mobility management, network-side authentication, and interfaces with public/external networks (e.g., the Internet). The access network 121 and the core network 122 may each comprise one or more network nodes for carrying out said functions.

In one embodiment, the service network 120 may be a 5G NR network, and the access network 121 and the core network 122 may be a Next Generation Radio Access Network (NG-RAN) and a Next Generation Core Network (NG-CN), respectively.

An NG-RAN may include one or more cellular stations, such as next generation NodeBs (gNBs), which support high frequency bands (e.g., above 24 GHz), and each gNB may further include one or more Transmission Reception Points (TRPs), wherein each gNB or TRP may be referred to as a 5G cellular station. Some gNB functions may be distributed across different TRPs, while others may be centralized, leaving the flexibility and scope of specific deployments to fulfill the requirements for specific cases.

A 5G cellular station may form one or more cells with different Component Carriers (CCs) for providing mobile services to the UE 110. For example, the UE 110 may camp on one or more cells formed by one or more gNBs or TRPs, wherein the cells which the UE 110 is camped on may be referred to as serving cells, including a Primary cell (Pcell) and one or more Secondary cells (Scells).

A NG-CN generally consists of various network functions, including Access and Mobility Function (AMF), Session Management Function (SMF), Policy Control Function (PCF), Application Function (AF), Authentication Server Function (AUSF), User Plane Function (UPF), and User Data Management (UDM), wherein each network function may be implemented as a network element on a dedicated hardware, or as a software instance running on a dedicated hardware, or as a virtualized function instantiated on an appropriate platform, e.g., a cloud infrastructure.

The AMF provides UE-based authentication, authorization, mobility management, etc. The SMF is responsible for session management and allocates Internet Protocol (IP) addresses to UEs. It also selects and controls the UPF for data transfer. If a UE has multiple sessions, different SMFs may be allocated to each session to manage them individually and possibly provide different functions per session. The AF provides information on the packet flow to PCF responsible for policy control in order to support Quality of Service (QoS). Based on the information, the PCF determines policies about mobility and session management to make the AMF and the SMF operate properly. The AUSF stores data for authentication of UEs, while the UDM stores subscription data of UEs.

In another embodiment, the RAT utilized by the service network 120 may be a future enhancement of the 5G NR technology. For example, the service network 120 may be a 6G, 7G, or 8G 3GPP network.

Alternatively, the application may also be applied to legacy RATs, such as the 4G LTE/LTE-A/TD-LTE technology. For example, the service network 120 may be a 4G LTE/LTE-A/TD-LTE network, and the access network 121 and the core network 122 may be an Evolved-Universal Terrestrial Radio Access Network (E-UTRAN) and an Evolved Packet Core (EPC), respectively.

An E-UTRAN may include one or more evolved NodeBs (eNBs) (e.g., macro eNBs, femto eNBs, or pico eNBs), wherein each eNB may be referred to as a 4G cellular station.

A 4G cellular station may form one or more cells with different CCs for providing mobile services to the UE 110. For example, the UE 110 may camp on one or more cells formed by one or more eNBs, wherein the cells which the UE 110 is camped on may be referred to as serving cells, including a Pcell and one or more Scells.

An EPC may include at least one Home Subscriber Server (HSS), Mobility Management Entity (MME), Serving Gateway (S-GW), and Packet Data Network Gateway (PDN-GW or P-GW).

The HSS is a central database that contains user-related and subscription-related information. The functions of the HSS include functionalities such as mobility management, call and session establishment support, user authentication and access authorization.

The MME is responsible for idle mode UE paging and tagging procedures including retransmissions. It is involved in the bearer activation/deactivation process and is also responsible for choosing the S-GW for the UE 110 at the initial attach and at time of intra-LTE handover involving Core Network (CN) node relocation. It is also responsible for user authentication (by interacting with the HSS) and generation/allocation of temporary identities to the UE 110. It is also the termination point in the network for ciphering/integrity protection for Non Access Stratum (NAS) signaling and handles the security key management.

The S-GW is responsible for routing and forwarding user data packets, while also acting as the mobility anchor for the user plane during inter-eNB handovers and as the anchor for mobility between LTE and other 3GPP technologies.

The P-GW provides connectivity from the UE 110 to external PDNs by being the point of exit and entry of traffic for the UE 110. The PGW also provides the functions of policy enforcement, packet filtering for each user, charging support, lawful interception, and packet screening.

It should be understood that the wireless communication environment 100 described in the embodiment of FIG. 1 are for illustrative purposes only and are not intended to limit the scope of the application.

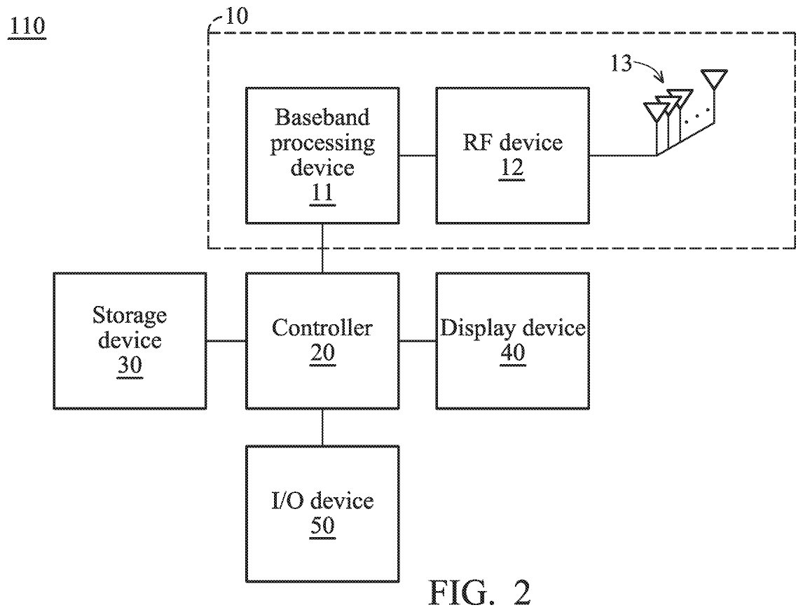

FIG. 2 is a block diagram illustrating the UE 110 according to an embodiment of the application.

As shown in FIG. 2, the UE 110 may include a wireless transceiver 10, a controller 20, a storage device 30, a display device 40, and an Input/Output (I/O) device 50.

The wireless transceiver 10 is configured to perform wireless transmission and reception to and from the service network 120.

Specifically, the wireless transceiver 10 may include a baseband processing device 11, a Radio Frequency (RF) device 12, and antenna 13, wherein the antenna 13 may include an antenna array for beamforming.

The baseband processing device 11 is configured to perform baseband signal processing and control the communications between subscriber identity card(s) (not shown) and the RF device 12. The baseband processing device 11 may contain multiple hardware components to perform the baseband signal processing, including Analog-to-Digital Conversion (ADC)/Digital-to-Analog Conversion (DAC), gain adjusting, modulation/demodulation, encoding/decoding, and so on.

The RF device 12 may receive RF wireless signals via the antenna 13, convert the received RF wireless signals to baseband signals, which are processed by the baseband processing device 11, or receive baseband signals from the baseband processing device 11 and convert the received baseband signals to RF wireless signals, which are later transmitted via the antenna 13. The RF device 12 may also contain multiple hardware devices to perform radio frequency conversion. For example, the RF device 12 may comprise a mixer to multiply the baseband signals with a carrier oscillated in the radio frequency of the supported RAT(s), wherein the radio frequency may be any radio frequency (e.g., 30 GHz-300 GHz for mmWave) utilized in the 5G NR technology, or may be 900 MHz, 2100 MHz, or 2.6 GHz utilized in LTE/LTE-A/TD-LTE technology, or another radio frequency, depending on the RAT in use.

The controller 20 may be a general-purpose processor, a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the wireless transceiver 10 for wireless communication with the service network 120, storing and retrieving data (e.g., program code) to and from the storage device 30, sending a series of frame data (e.g. representing text messages, graphics, images, etc.) to the display device 40, and receiving user inputs or outputting signals via the I/O device 50.

In particular, the controller 20 coordinates the aforementioned operations of the wireless transceiver 10, the storage device 30, the display device 40, and the I/O device 50 for performing the method for a UE to provide assistance information to transition out of an RRC_CONNECTED state.

In another embodiment, the controller 20 may be incorporated into the baseband processing device 11, to serve as a baseband processor.

As will be appreciated by persons skilled in the art, the circuits of the controller 20 will typically include transistors that are configured in such a way as to control the operation of the circuits in accordance with the functions and operations described herein. As will be further appreciated, the specific structure or interconnections of the transistors will typically be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 30 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data, instructions, and/or program code of applications, communication protocols, and/or the method of the present application.

The display device 40 may be a Liquid-Crystal Display (LCD), a Light-Emitting Diode (LED) display, an Organic LED (OLED) display, or an Electronic Paper Display (EPD), etc., for providing a display function. Alternatively, the display device 40 may further include one or more touch sensors disposed thereon or thereunder for sensing touches, contacts, or approximations of objects, such as fingers or styluses.

The I/O device 50 may include one or more buttons, a keyboard, a mouse, a touch pad, a video camera, a microphone, and/or a speaker, etc., to serve as the Man-Machine Interface (MIMI) for interaction with users.

It should be understood that the components described in the embodiment of FIG. 2 are for illustrative purposes only and are not intended to limit the scope of the application.

For example, a UE may include more components, such as a power supply, and/or a Global Positioning System (GPS) device, wherein the power supply may be a mobile/replaceable battery providing power to all the other components of the UE, and the GPS device may provide the location information of the UE for use by some location-based services or applications. Alternatively, a UE may include fewer components. For example, the UE may not include the display device 40 and/or the I/O device 50.

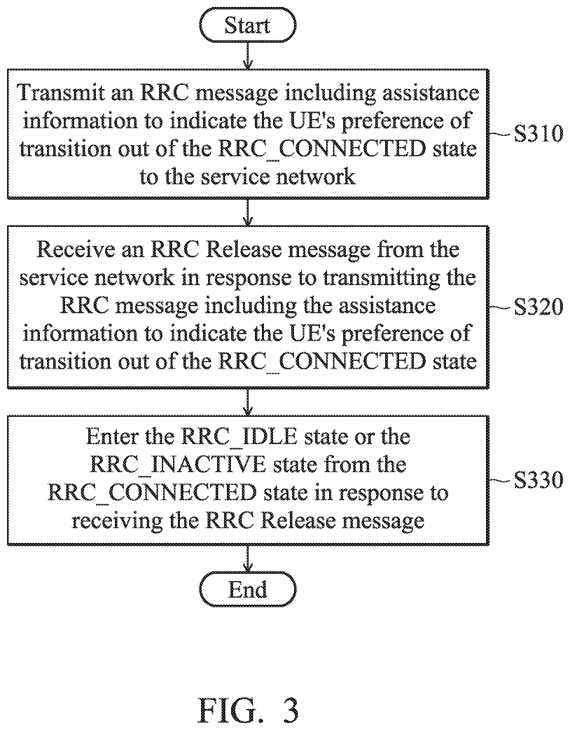

FIG. 3 is a flow chart illustrating the method for a UE to provide assistance information to transition out of an RRC_CONNECTED state according to an embodiment of the application.

In this embodiment, the method for a UE to provide assistance information to transition out of an RRC_CONNECTED state may be applied to and executed by a UE (e.g., the UE 110) wirelessly connected to a service network (e.g., the service network 120).

To begin with, the UE transmits an RRC message including assistance information to indicate the UE's preference of transition out of the RRC_CONNECTED state to the service network (step S310).

Specifically, the transmission of the RRC message including the assistance information to indicate the UE's preference of transition out of the RRC_CONNECTED state is performed in response to the UE being configured during an RRC reconfiguration procedure to provide the assistance information.

In one embodiment, the UE may receive an RRCReconfiguration message from the service network during the RRC reconfiguration procedure, wherein the RRCReconfiguration message may include the “otherConfig” IE which includes the “releasePreferenceConfig” IE being set to “setup” to indicate the UE to provide the assistance information.

In one embodiment, the RRC message may be a UEAssistanceInformation message in compliance with the 3GPP Technical Specification (TS) 38.331 for NR, and the assistance information may refer to a preferred RRC state (e.g., the RRC_IDLE state or the RRC_INACTIVE state) which may be included in the “ReleasePreference” IE in the UEAssistanceInformation message.

The preferred RRC state may be determined based on the traffic pattern or the mobility state of the UE. For example, if the UE is in low mobility and has an infrequent and small data traffic pattern, the preferred RRC state may be the RRC_INACTIVE state. If the UE is in high mobility or the interval between data arrival is even longer, the preferred RRC state may be the RRC_IDLE state.

Next, the UE receives an RRC Release message from the service network in response to transmitting the RRC message including the assistance information to indicate the UE's preference of transition out of the RRC_CONNECTED state (step S320).

After that, the UE releases the RRC connection with the service network and enters the RRC_IDLE state or the RRC_INACTIVE state from the RRC_CONNECTED state in response to receiving the RRC Release message (step S330), and the method ends.

Please note that the 3GPP specifications mentioned herein are used to teach the spirit of the application, and the application should not be limited thereto.

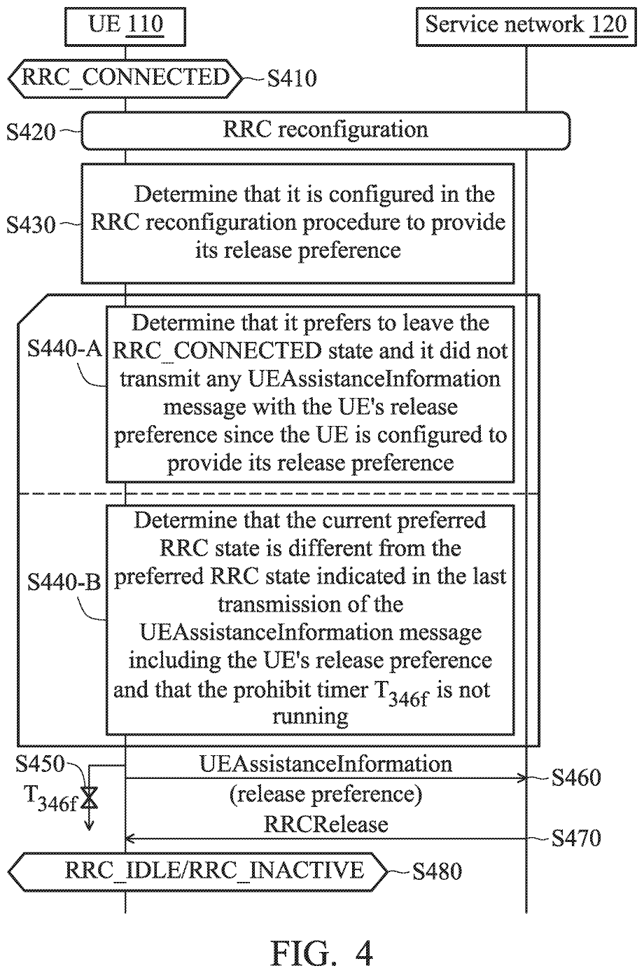

FIG. 4 is a message sequence chart illustrating the provision of assistance information for the UE 110 to transition out of the RRC_CONNECTED state according to an embodiment of the application.

In step S410, the UE 110 is configured to be in the RRC_CONNECTED state at the start of the method of the present application. That is, the UE 110 has performed an RRC establishment procedure to establish an RRC connection with the service network 120.

In step S420, the UE 110 performs an RRC reconfiguration procedure with the service network 120.

In step S430, the UE 110 determines that it is configured in the RRC reconfiguration procedure to provide its release preference (i.e., assistance information to indicate the UE's preference of transition out of the RRC_CONNECTED state).

In step S440-A, the UE 110 determines that it prefers to leave the RRC_CONNECTED state and it did not transmit any UEAssistanceInformation message with the UE's release preference since the UE is configured to provide its release preference.

Alternatively, in step S440-B, the UE 110 determines that the current preferred RRC state is different from the preferred RRC state indicated in the last transmission of the UEAssistanceInformation message including the UE's release preference and that the prohibit timer T_{346f} is not running.

In step S450, the UE 110 starts the prohibit timer T_{346f}.

In step S460, the UE 110 transmits the UEAssistanceInformation message including the UE's release preference to the service network 120.

In one embodiment, the prohibit timer T_{346f} may be started upon the transmission of the UEAssistanceInformation message with the UE's release preference.

Specifically, the UE 110 is prohibited from transmitting UEAssistanceInformation message with the UE's release preference again during the RRC connection, until the prohibit timer T_{346f} expires.

In step S470, the UE 110 receives an RRCRelease message from the service network 120.

In step S480, the UE 110 enters the RRC_IDLE state or the RRC_INACTIVE state from the RRC_CONNECTED state in response to receiving the RRCRelease message.

In another embodiment, the UE 110 may start a release timer by the UE upon the transmission of the UEAssistanceInformation message with the UE's release preference, and enter the RRC_IDLE state or the RRC_INACTIVE state from the RRC_CONNECTED state in response to the release timer expiring and the UE 110 not receiving any RRCRelease message from the service network 120.

In view of the forgoing embodiments, it will be appreciated that the present application allows a UE to indicate its preference of transition out of the RRC_CONNECTED state via RRC signaling, thereby triggering the network side to release the RRC connection for the UE to leave the RRC_CONNECTED state. Advantageously, the power savings accrued by the UE may be improved.

While the application has been described by way of example and in terms of preferred embodiment, it should be understood that the application is not limited thereto. Those who are skilled in this technology can still make various alterations and modifications without departing from the scope and spirit of this application. Therefore, the scope of the present application shall be defined and protected by the following claims and their equivalents.

What is claimed is:

1. A User Equipment (UE), comprising:
a wireless transceiver, configured to perform wireless transmission and reception to and from a service network; and
a controller, configured to transmit a Radio Resource Control (RRC) message comprising assistance information to indicate the UE's preference of transition out of an RRC_CONNECTED state to the service network via the wireless transceiver, receive an RRC Release message from the service network via the wireless transceiver in response to transmitting the RRC message comprising the assistance information to indicate the UE's preference of transition out of the RRC_CONNECTED state, and configure the UE to enter an RRC_IDLE state or an RRC_INACTIVE state from the RRC_CONNECTED state in response to receiving the RRC Release message.

2. The UE of claim 1, wherein the assistance information indicates a preferred RRC state of the UE, and the preferred RRC state is the RRC_IDLE state or the RRC_INACTIVE state.

3. The UE of claim 2, wherein the preferred RRC state is determined based on a traffic pattern or a mobility state of the UE.

4. The UE of claim 1, wherein the controller is further configured to start a prohibit timer upon the transmission of the RRC message comprising the assistance information to indicate the UE's preference of transition out of the RRC_CONNECTED state, and prohibit transmission of another RRC message comprising the assistance information to indicate the UE's preference of transition out of the RRC_CONNECTED state to the service network until the prohibit timer expires.

5. The UE of claim 1, wherein the transmission of the RRC message comprising the assistance information to indicate the UE's preference of transition out of the RRC_CONNECTED state is performed in response to the UE being configured during an RRC reconfiguration procedure to provide the assistance information.

6. The UE of claim 5, wherein the transmission of the RRC message comprising the assistance information to indicate the UE's preference of transition out of the RRC_CONNECTED state is performed in response to the UE preferring to leave the RRC_CONNECTED state and the UE not transmitting any RRC message comprising the assistance information to indicate the UE's preference of transition out of the RRC_CONNECTED state since the UE is configured to provide the assistance information.

7. The UE of claim 5, wherein the transmission of the RRC message comprising the assistance information to indicate the UE's preference of transition out of the RRC_CONNECTED state is performed in response to a prohibit timer is not running and a current preferred RRC state of the UE being different from a preferred RRC state indicated in a last transmission of another RRC message comprising the assistance information to indicate the UE's preference of transition out of the RRC_CONNECTED state.

8. The UE of claim 1, wherein the RRC message is a UEAssistanceInformation message in compliance with a Third Generation Partnership Project (3GPP) Technical Specification (TS) 38.331 for New Radio (NR).

9. The UE of claim 1, wherein the controller is further configured to start a release timer upon the transmission of the RRC message comprising the assistance information to indicate the UE's preference of transition out of the RRC_CONNECTED state, and configure the UE to enter the RRC_IDLE state or the RRC_INACTIVE state from the RRC_CONNECTED state in response to the release timer expiring and the UE not receiving any RRC Release message from the service network.

10. A method, comprising:
transmitting a Radio Resource Control (RRC) message comprising assistance information to indicate a UE's preference of transition out of an RRC_CONNECTED state to a service network by the UE;
receiving an RRC Release message from the service network by the UE in response to transmitting the RRC message comprising the assistance information to indicate the UE's preference of transition out of the RRC_CONNECTED state; and
entering an RRC_IDLE state or an RRC_INACTIVE state from the RRC_CONNECTED state by the UE in response to receiving the RRC Release message.

11. The method of claim 10, wherein the assistance information indicates a preferred RRC state of the UE, and the preferred RRC state is the RRC_IDLE state or the RRC_INACTIVE state.

12. The method of claim 11, wherein the preferred RRC state is determined based on a traffic pattern or a mobility state of the UE.

13. The method of claim 10, further comprising:
starting a prohibit timer by the UE upon the transmission of the RRC message comprising the assistance information to indicate the UE's preference of transition out of the RRC_CONNECTED state; and
prohibiting transmission of another RRC message comprising the assistance information to indicate the UE's preference of transition out of the RRC_CONNECTED state to the service network by the UE until the prohibit timer expires.

14. The method of claim 10, wherein the transmission of the RRC message comprising the assistance information to indicate the UE's preference of transition out of the RRC_CONNECTED state is performed in response to the UE being configured during an RRC reconfiguration procedure to provide the assistance information.

15. The method of claim 14, wherein the transmission of the RRC message comprising the assistance information to indicate the UE's preference of transition out of the RRC_CONNECTED state is performed in response to the UE preferring to leave the RRC_CONNECTED state and the UE not transmitting any RRC message comprising the assistance information to indicate the UE's preference of transition out of the RRC_CONNECTED state since the UE is configured to provide the assistance information.

16. The method of claim 14, wherein the transmission of the RRC message comprising the assistance information to indicate the UE's preference of transition out of the RRC_CONNECTED state is performed in response to a prohibit timer is not running and a current preferred RRC state of the UE being different from a preferred RRC state indicated in a last transmission of another RRC message comprising the assistance information to indicate the UE's preference of transition out of the RRC_CONNECTED state.

17. The method of claim 10, wherein the RRC message is a UEAssistanceInformation message in compliance with a Third Generation Partnership Project (3GPP) Technical Specification (TS) 38.331 for New Radio (NR).

18. The method of claim 10, further comprising:
starting a release timer by the UE upon the transmission of the RRC message comprising the assistance information to indicate the UE's preference of transition out of the RRC_CONNECTED state; and
entering the RRC_IDLE state or the RRC_INACTIVE state from the RRC_CONNECTED state by the UE in response to the release timer expiring and the UE not receiving any RRC Release message from the service network.
